(19) United States
(12) Patent Application Publication
(10) Pub. No.: US 2002/0080323 A1
(43) Pub. Date: Jun. 27, 2002

(54) Method of producing micro-lenses and image display device with the same

(76) Inventor: Hiroaki Muroya, Kagoshimaa (JP)

Correspondence Address: SONNENSCHEIN NATH & ROSENTHAL, P.O. BOX 061080, WACKER DRIVE STATION, CHICAGO, IL, 60606-1080, US

(21) Appl. No.: 09/931,343

(22) Filed: Aug. 16, 2001

(30) Foreign Application Priority Data
Aug. 16, 2000 (JP) P2000-246872

(51) Int. Cl. G02F 1/13

(52) U.S. Cl. 349/187

(57) ABSTRACT

A method of producing micro-lenses used in an image display device not requiring positioning of the micro-lenses and an image display device provided with the micro-lenses capable of displaying images of high luminance and a high contrast. The method includes the steps of: forming a TFT substrate having a plurality of pixel electrodes, a switching element, and light blocking layers having a predetermined apertures covering clearances of the pixel electrodes on a first light transmitting type substrate; forming a counter substrate having counter electrodes on a second light transmitting type substrate; arranging the TFT substrate and the counter substrate to face each other and bonding peripheries of the substrates; forming a focusing layer containing a photosensitive material on a surface facing the bonding surface of the counter substrate; irradiating light from the TFT substrate side to expose portions of the focusing layer facing the apertures of the light blocking layer; and exposing unexposed portions of the focusing layer.

### BACKGROUND OF THE INVENTION

1. Field of the Invention

The present invention relates to a method of producing micro-lenses and an image display device using the same, more particularly relates to a method of producing micro-lenses capable of focusing light with a high efficiency and an image display device provided with a display screen of a high luminance using the same.

2. Description of the Related Art

In recent years, liquid crystal display devices and other image display devices have been made finer in pixels and greater in degree of integration. In the case of a direct-view type, for example, a liquid crystal display device, screens are being made larger in size and greater in definition.

On the other hand, in order to realize a further larger size of the screen, a projection type liquid crystal display device (liquid crystal projector) etc. are being developed.

Below, the explanation will be made on a projection type liquid crystal display device as an example.

A liquid crystal projector makes good use of its feature of the ability to display a large area screen by a small size device. It forms an image on a small liquid crystal display panel, passes a light source beam through this liquid crystal display panel, and magnifies and projects it to an external screen via an optical system in a front of the panel to form a large picture.

In order to further effectively use this feature of a liquid crystal projector, techniques for further reducing the size of the liquid crystal display device used for this are being studied and developed.

For example, even when using a liquid crystal display device of a panel size of about 0.7 inch diagonally, in order to improve the quality of the projected and magnified image, it is necessary to form at least 300,000 pixels on the liquid crystal display panel. Efforts are being made to increase the definition and integration of liquid crystal display panels in order to realize such a liquid crystal display panel having a large number of pixels.

As the technique enabling such a request to be achieved, the method of forming a pixel switching element and a liquid crystal drive circuit by thin film transistors (TFT) using polycrystalline silicon and various means for improving the numerical aperture of each pixel at the time of formation of pixels with a high definition and integration are being researched and developed.

Particularly, in the liquid crystal projector explained above, the first thing demanded from smaller sized liquid crystal display panel is to raise the luminance (raise the efficiency of the transmitted light).

In the past, however, a numerical aperture of a display panel of only about 30 to 40% at most can be obtained from the viewpoint of the precision of processing in the process of production of a liquid crystal display device, so the limit is already being reached in the improvement of the luminance by the approach of improvement of the efficiency of utilization of the transmitted light. In actuality, the light which is not utilized is reflected at a light blocking film (black matrix) and discarded without being used for the display.

Here, generally, in an active matrix type liquid crystal display device, the light blocking film has become an indispensable part since also the function of suppressing the optical leakage current of thin film transistors (TFTs) and blocking clearances between pixels and the cleaning up the screen is necessary.

Further, particularly in small sized and high definition liquid crystal display panels, the numerical aperture tends to further conspicuously fall along with a further reduction in size of pixels and increase of number of pixels. The fall in the luminance of the displayed image and the fall in the contrast ratio due to this are becoming disadvantages.

Therefore, as a technique for overcoming the above disadvantages, there is a method of performing positioning for each pixel and processing the same by machining or etching to form micro-lenses.

In the related art method, however, while it does become possible to increase the amount of the light passing through the apertures of the light blocking film by the micro-lenses, the reduction of size of image display devices provided with micro-lenses in recent years has led to a need for a higher precision of superposition of the counter substrate equipped with micro-lenses and TFT substrate.

It is extremely difficult in practice to correctly position and superpose fine-dimension micro-lenses for many pixels. If the micro-lenses and pixels are not matched well, a reduction of the light transmission rate occurs and the quality of the display is conspicuously lowered.

Also, when producing a liquid crystal projector or the like used at a high temperature, it is necessary to use a thermosetting sealing agent having a high reliability. Due to the difference of the thermal expansion coefficients between the counter substrate equipped with micro-lenses and the TFT substrate, even if the micro-lenses and pixels are correct matched at the time of superimposition, deviation occurs after the heat treatment and a reduction of the light transmission rate occurs in the same way as described above.

Further, there are also the disadvantages that the production steps increase when producing a micro-lens master corresponding to the pixel pattern as in the related art and formation of mis-shaped micro-lenses due to deterioration of the micro-lens master.

Taking the deviation of positioning described above into account, Japanese Unexamined Patent Publication (Kokai) No. 10-339870 discloses a technique eliminating the need for positioning of a light blocking film and a transparent insulating substrate when forming micro-lenses on one surface of the transparent insulating substrate and forming the light blocking film on the other surface, but even by such a method, positioning with the TFT substrate is necessary after that, so disadvantages similar to those described above will occur.

### SUMMARY OF THE INVENTION

An object of the present invention is to provide a method of producing micro-lenses used for an image display device not requiring positioning of the micro-lenses.

Another object of the present invention is to provide a method of producing an image display device provided with micro-lenses capable of displaying an image having a high luminance and a high contrast.

To attain the first object, according to a first aspect of the present invention, there is provided a method of producing micro-lenses, including the steps of: forming a plurality of pixel electrodes on a first light transmitting type substrate to form a first substrate; forming counter electrodes on a second light transmitting type substrate to form a second substrate; forming a light blocking layer having apertures in at least portions corresponding to said pixel electrodes on at least one of said first and second substrates; bonding peripheries of said first and second substrates so that said pixel electrodes and said counter electrodes face each other with a clearance therebetween; forming a focusing layer containing a photosensitive material on a surface of said second substrate facing said bonding surface; irradiating light from said first substrate side to expose and cure the portions of said focusing layer facing the apertures of said light blocking film by light transmitted through the apertures of said light blocking layer; and removing uncured portions of said focusing layer, to thereby form the cured portions of said focusing layer as micro-lenses for focusing the light incident from said focusing layer side to the apertures of said light blocking layer.

To attain the second object, according to a second aspect of the present invention, there is provided a method of producing an image display device, including the steps: of forming a plurality of pixel electrodes on a first light transmitting type substrate and forming a switching element connected to the pixel electrodes to form a first substrate; forming counter electrodes on a second light transmitting type substrate to form a second substrate; forming on at least one of said first substrate and said second substrate a light blocking layer covering said switching element and clearances among said pixel electrodes and having apertures at least at portions corresponding to said pixel electrodes; bonding peripheries of said first and second substrates so that said pixel electrodes and said counter electrodes face each other with a clearance therebetween; forming a focusing layer containing a photosensitive material on a surface of said second substrate facing said bonding surface; irradiating light from said first substrate side to expose and cure the portions of said focusing layer facing the apertures of said light blocking film by the light transmitted through the apertures of said light blocking layer; and removing uncured portions of said focusing layer, to thereby form the cured portions of said focusing layer as micro-lenses for focusing the light incident from said focusing layer side to the apertures of said light blocking layer.

Preferably, in the step of irradiating the light from said first substrate side, schematically parallel beams are used as the light. Alternatively, in the step of irradiating the light from said first substrate side, at least two beams having different angles with respect to a normal direction perpendicular to the light irradiated surface of said first substrate are irradiated. Alternatively, in the step of irradiating the light from said first substrate side, a beam having a predetermined angle with respect to the normal direction perpendicular to the light irradiated surface of said first substrate is irradiated while rotating the same about the related normal direction.

According to the methods of production of the micro-lenses and image display device of the present invention described above, the steps for forming the micro-lenses are performed after forming the first substrate having a plurality of pixel electrodes and the switching element connected to them, forming the second substrate having the counter electrodes, forming the light blocking layer having the predetermined apertures on at least one of said first substrate and said second substrate, arranging the first and second substrates to face each other, and bonding their peripheries.

Then, by forming the focusing layer containing the photosensitive material on the surface facing the bonding surface of the second substrate and irradiating light from the first substrate side, the portions of the focusing layer facing the apertures of the light blocking layer are exposed by the light transmitted through the apertures of the light blocking layer. By removing the unexposed portions of the focusing layer, the exposed portions of the focusing layer are formed as micro-lenses.

Accordingly, the positioning of the micro-lenses with respect to the light blocking layer and pixel electrodes is unnecessary, so an image display device provided with micro-lenses capable of displaying a high luminance and high contrast image can be produced.

### BRIEF DESCRIPTION OF THE DRAWINGS

These and other objects and features of the present invention will become clearer from the following description with reference to the attached drawings, wherein:

FIGS. 1A to 1C are sectional views of steps of the methods of production of micro-lenses and an image display device of the related art, in which FIG. 1A shows the state up to the step of coating an ultraviolet curing resin onto a transparent insulating substrate, FIG. 1B shows the state up to a step of shaping the ultraviolet curing resin by a micro-lens master, and FIG. 1C shows the state up to a step of curing the ultraviolet curing resin;

FIGS. 2A and 2B are views of steps continuing from FIG. 1C, in which FIG. 2A shows the state up to the step of formation of the adhesive layer and FIG. 2E shows the state up to the step of formation of a covering transparent insulating substrate;

FIGS. 3A and 3B are views of steps continuing from FIG. 2B, in which FIG. 3A shows the state up to the step of formation of a transparent common electrode and an orientation film and FIG. 3B shows the state up to the step of formation of a TFT substrate and bonding of the counter substrate and the TFT substrate;

FIG. 4A is a sectional view of an image display device of the present embodiment, and FIG. 4B is a perspective view of micro-lenses formed on a transparent insulating substrate;

FIGS. 5A and 5B are sectional views of steps of methods of production of micro-lenses and an image display device of the present invention, in which FIG. 5A shows the state up to the step of formation of a TFT substrate and a counter substrate and FIG. 5B shows the state up to a step of bonding the TFT substrate and counter substrate and injecting a liquid crystal;

FIGS. 6A and 6B are views of steps continuing from FIG. 5B, in which FIG. 6A shows the state up to a step of coating an ultraviolet curing resin and FIG. 6B shows the state up to a first ultraviolet irradiation step;

FIGS. 7A and 7B are views of steps continuing from FIG. 6B, in which FIG. 7A shows the state up to a second ultraviolet irradiation step and FIG. 7B shows the state up to a third ultraviolet irradiation step;

FIGS. 8A and 8B are views of steps continuing from FIG. 7B, in which FIG. 8A shows the state up to the step of formation of the micro-lenses and FIG. 8B shows the state up to the step of formation of an adhesive layer;

FIG. 9 is a perspective view of the TFT substrate with pixel electrodes and a light blocking film formed thereon;

FIG. 10 is a perspective view of the micro-lenses formed when the ultraviolet light is irradiated on an identical plane but varying in angle; and

FIG. 11 is a sectional view of a step of the methods of production of micro-lenses and an image display device according to a second embodiment of the present invention.

### DESCRIPTION OF THE PREFERRED EMBODIMENTS

Here, for reference,, before describing the preferred embodiments, an explanation will be made of a concrete example of a related art method of production of a image display device provided with micro-lenses by referring to the drawings.

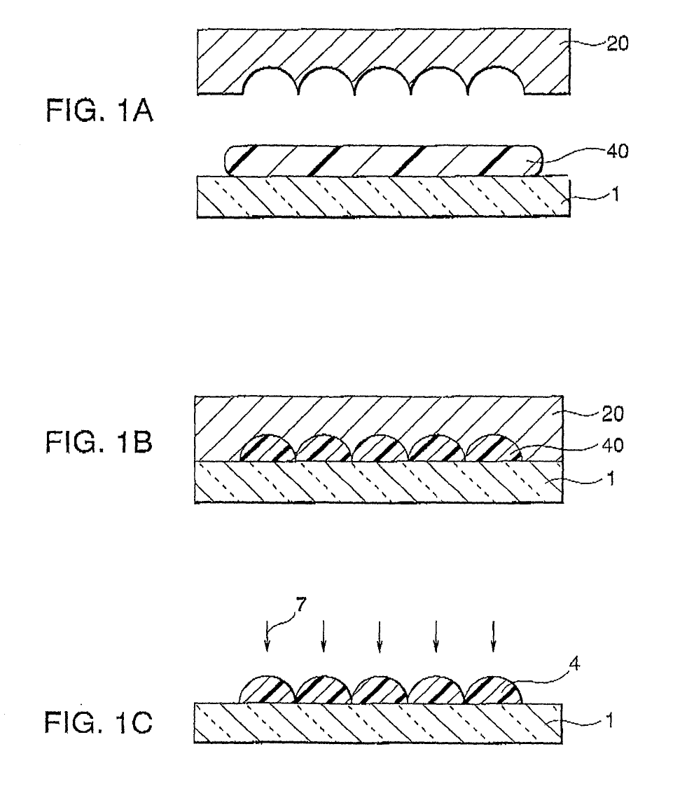

First, as shown in FIG. 1A, a micro-lens master (stamper) 20 corresponding to the pixel pattern is produced in advance by electroforming or wet etching.

Topology for forming the micro-lenses are formed on the shaping surface of this micro-lens master 20.

Then, for example, an ultraviolet curing resin 40 having a high refractive index for forming the micro-lenses is coated between the micro-lens master 20 and a transparent insulating substrate 1 for forming the micro-lenses.

Note that it is also possible to use a thermosetting resin having a high refractive index in place of the ultraviolet curing resin.

Next, as shown in FIG. 1B, the micro-lens master 20 is pressed against the transparent insulating substrate 1 with the ultraviolet curing resin 40 formed thereon to spread the high refractive index resin 40.

Next, as shown in FIG. 1C, the micro-lens master 20 is removed and ultraviolet light 7 is irradiated to cause the ultraviolet curing resin 40 to cure, whereby semi-spherical micro-lenses 4 are formed.

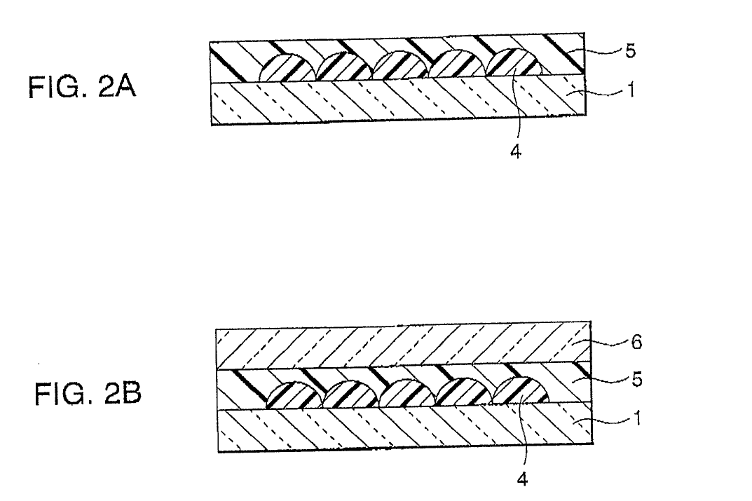

Next, as shown in FIG. 2A, an ultraviolet curing resin having a different refractive index from that of the micro-lenses 4, for example, a low refractive index, is coated to form an adhesive layer 5.

Next, as shown in FIG. 2B, a covering transparent insulating substrate 6 for protecting the micro-lenses is bonded to the transparent insulating substrate 1 via the adhesive layer 5, whereby a transparent insulating substrate 1 equipped with micro-lenses is completed.

Note that, the micro-lens master 20 finishing the shaping is washed at its shaping surface, then used for the next shaping step.

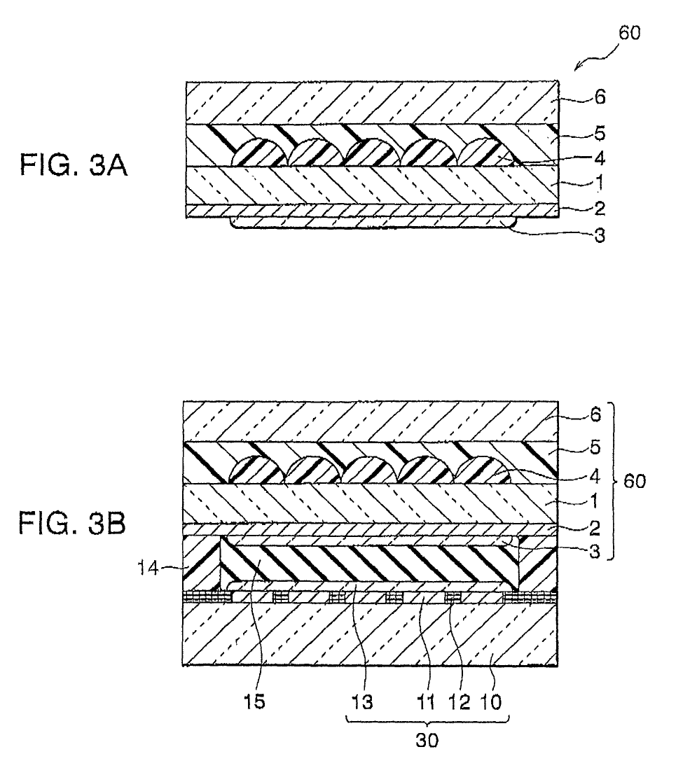

Next, as shown in FIG. 3A, a transparent common electrode 2 and an orientation film 3 are formed on the surface of the transparent insulating substrate 1 on the side where the micro-lenses are not formed to thereby form a counter substrate 60 equipped with micro-lenses.

Finally, as shown in FIG. 3B, for example, a TFT substrate 30 having a large number of pixel electrodes 11 in the form of a matrix, a not illustrated large number of thin film transistors (TFT) connected to such pixel electrodes 11 and interconnections, light blocking films 12 covering the thin film transistors and areas between adjacent pixel electrodes 11, and orientation films 13 covering the pixel electrodes 11 and the light blocking films 12 is formed on the transparent insulating substrate 10 by a known method, the related TFT substrate 30 and the counter substrate 60 equipped with micro-lenses are arranged to face each other so that the pixel electrodes 11 and the transparent common electrode 2 face each other, their peripheries are sealed by a sealing agent 14, and a liquid crystal 15 is injected between these two substrates (30, 60), whereby a liquid crystal display device is formed.

As explained above, however, in this related art method, while it does become possible to increase the amount of the light passing through the apertures of the light blocking film by the micro-lenses, the reduction of size of image display devices provided with micro-lenses in recent years has led to a need for a higher precision of superposition of the counter substrate 60 equipped with micro-lenses and the TFT substrate 30 shown in FIG. 3B.

Also, as explained earlier, it is extremely difficult in practice to correctly position and superpose fine-dimension micro-lenses for many pixels. If the micro-lenses and pixels are not matched well, a reduction of the light transmission rate occurs and the quality of the display is conspicuously lowered.

Also, when producing a liquid crystal projector or the like used at a high temperature, it is necessary to use a thermosetting sealing agent having a high reliability. Due to the difference of the coefficients of thermal expansion between the counter substrate 60 equipped with micro-lenses and the TFT substrate 30, even if the micro-lenses and pixels are correct matched at the time of superimposition, deviation occurs after the heat treatment and a reduction of the light transmission rate occurs in the same way as described above.

Further, there are also the disadvantages that the production steps increase when producing a micro-lens master 20 corresponding to the pixel pattern as in the related art and formation of mis-shaped micro-lenses due to deterioration of the micro-lens master 20.

Next, an explanation will be made of methods of production of micro-lenses and an image display device according to preferred embodiments of the present invention by referring to the drawings.

First Embodiment

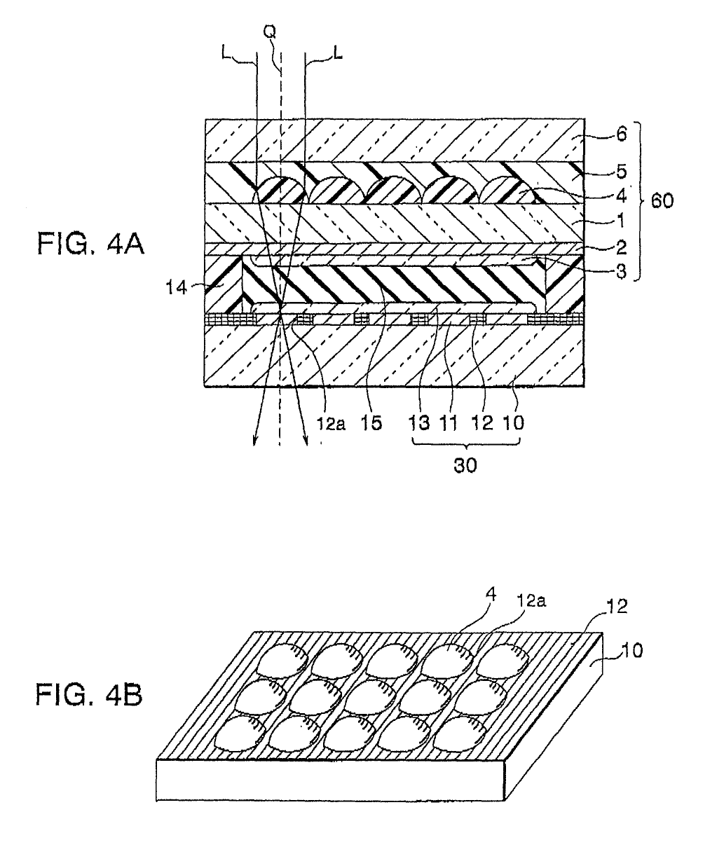

FIGS. 4A and 4B are sectional views of an image display device of the present embodiment.

As shown in FIGS. 4A and 4B, the image display device of a first embodiment of the present invention has a TFT substrate (liquid crystal drive substrate) 30, a counter substrate 60 equipped with micro-lenses bonded to the TFT substrate 30, and a substance layer 15 made of for example liquid crystal sealed in the clearance between the TFT substrate 30 and the counter substrate 60 equipped with micro-lenses.

In the counter substrate 60 equipped with micro-lenses, micro-lenses 4 comprised of a large number of convex portions are formed on one surface of the transparent insulating substrate 1. A covering transparent insulating substrate 6 for protecting the micro-lenses is formed on the micro-lenses 4 via an adhesive layer 5.

On the other surface of the transparent insulating substrate 1, a transparent common electrode 2 is formed. An orientation film 3 is formed on the transparent common electrode 2.

The TFT substrate 30 is a substrate for driving for example the liquid crystals of the substance layer 15. It has a transparent insulating substrate 10, a large number of transparent pixel electrodes 11 formed on the transparent insulating substrate 10, a not illustrated large number of thin film transistors (TFT) formed in the vicinity of the pixel electrodes 11 corresponding to the pixel electrodes 11, and interconnections. Light blocking films 12 are formed covering the thin film transistors and the areas between adjacent pixel electrodes 11.

An orientation film 13 is formed covering the pixel electrodes 11 and the light blocking films 12.

In the above image display device, the TFT substrate 30 and the counter substrate 60 equipped with micro-lenses are bonded with a predetermined distance therebetween so that the transparent common electrode 2 of the counter substrate 60 equipped with micro-lenses and the pixel electrodes 11 of the TFT substrate 30 face each other.

The pixel electrodes 11 drive for example the liquid crystals of the substance layer 15 by charging and discharging with the transparent common electrode 2.

The not illustrated thin film transistors are connected to the corresponding pixel electrodes 11 in their vicinities. Also, the thin film transistors are connected to a not illustrated control circuit and control the current supplied to the pixel electrodes 11. Due to this, the charging and discharging of the pixel electrodes are controlled.

The substance layer 15 contains for example liquid crystal molecules. The orientations of such liquid crystal molecules change corresponding to the charging and discharging of the pixel electrodes 11.

Usually, one micro-lens 4, one aperture 12a of the light blocking film corresponding to an optical axis Q of the micro-lens 4, one pixel electrode 11, and one not illustrated thin film transistor connected to that pixel electrode 11 correspond to one pixel.

An incident beam L incident from the covering transparent insulating substrate 6 side passes through the covering transparent insulating substrate 6 and passes through the transparent insulating substrate 1, transparent common electrode 2, orientation film 3, substance layer 15, orientation film 13, pixel electrode 11, and the transparent insulating substrate 10 while being focused when passing through a micro-lens 4 via the adhesive layer 5.

Note that, at this time, on the incident side of the counter substrate 60 equipped with micro-lenses, usually a not illustrated polarization plate is arranged. Therefore, when the incident beam L passes through the substance layer 15, the incident beam becomes linearly polarized light.

At this time, the incident beam L which has become the linearly polarized light is controlled in its polarization direction when emitted from the substance layer 15 corresponding to the orientation state of for example the liquid crystal molecules of the substance layer 15.

Accordingly, by controlling the passage of the incident beam L through the substance layer 15, orientation film 13, pixel electrode 11, and the transparent insulating substrate 10 to the not illustrated polarization plate on the TFT substrate 30 side, the luminance of the emitted beam can be controlled.

In the above image display device, as shown in FIG. 4B, the not illustrated pixel electrodes 11 are formed below the micro-lenses 4, and the light blocking films 12 are provided between adjacent pixel electrodes 11, so leakage of the unnecessary light from portions other than the pixels can be prevented, and a clear image can be obtained.

Also, since the image display device has the micro-lenses 4, the incident beam L passing through each microlens 4 is focused and passes through the aperture 12a of a light blocking film. Accordingly, in the image display device according to the present embodiment, attenuation of the incident beam L due to the reflection at the light blocking film 12 is suppressed. Namely, an image exhibiting a high transmission rate of light at the pixel portion and having a good brightness with a relatively small amount of light can be formed.

Next, an explanation will be made of the method of production of an image display device provided with the micro-lenses of the present embodiment.

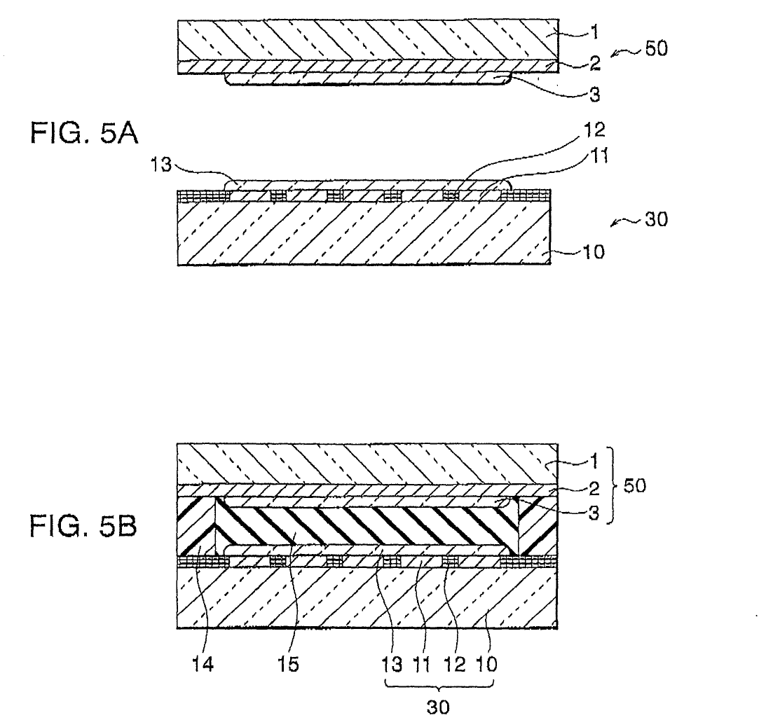

First, as shown in FIG. 5A, a transparent common electrode 2 made of for example indium tin oxide (ITO) is formed on one surface of the transparent insulating substrate 1, and an orientation film 3 is formed (including rubbing) on the transparent common electrode 2 to thereby form a counter substrate 50.

Also, not illustrated thin film transistors (TFT), not illustrated interconnections, and pixel electrodes 11 are formed on the transparent insulating substrate 10 by a known method. Further, light blocking films 12 covering the TFTs and areas between adjacent pixel electrodes 11 are formed, an orientation film 13 is formed (including rubbing) covering the pixel electrodes 11 and light blocking films 12, and thus a TFT substrate 30 is formed.

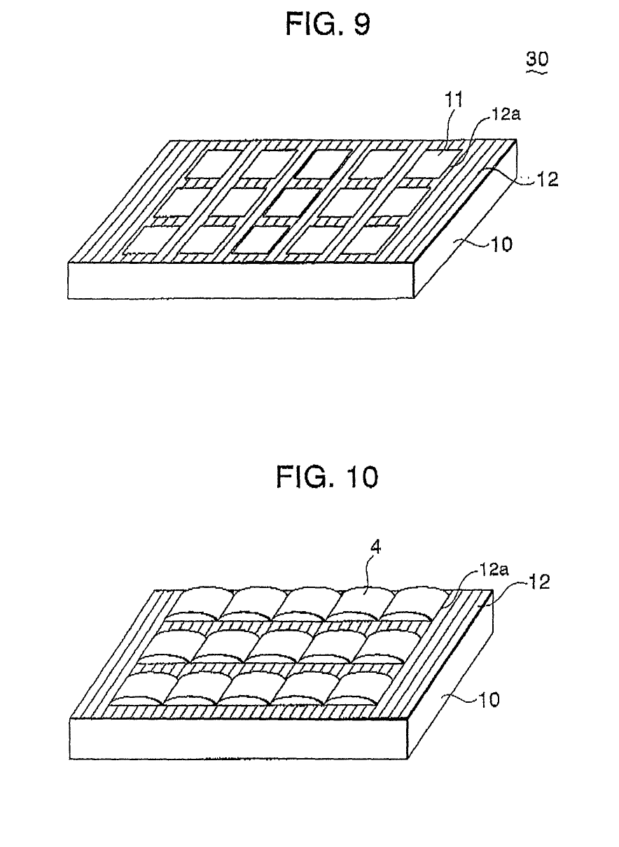

A perspective view of the TFT substrate 30 is shown in FIG. 9. On the TFT substrate, transparent pixel electrodes 11 formed in the form of for example a matrix an light blocking films (black matrix) formed between the pixel electrodes 11 are arranged as shown in FIG. 9.

Next, as shown in FIG. 5B, the TFT substrate 30 and the counter substrate 50 are arranged to face each other with a clearance therebetween. Their peripheries are bonded while sealing them by a sealing agent 14 made of for example of a thermosetting resin.

Then, a not illustrated injection hole is formed, for example a liquid crystal composition is injected into the clearance, the injection hole is closed, and therefore the liquid crystal composition is sealed and held between the TFT substrate 30 and the counter substrate 50.

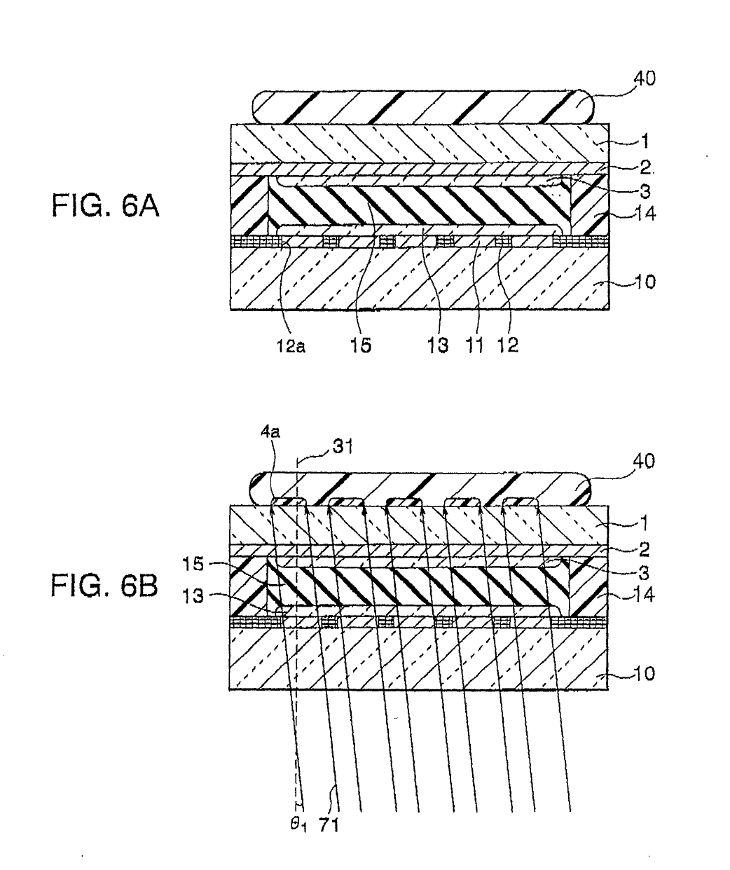

Next, as shown in FIG. 6A, for example, an ultraviolet curing resin (focusing layer) 40 having a high refractive index is formed on the transparent insulating substrate 1 on the surface opposite to the surface with the transparent common electrode 2 formed thereon.

Next, as shown in FIG. 6B, ultraviolet light 71 of for example parallel beams is uniformly irradiated from the side of the transparent insulating substrate 10 where the light blocking film 12 is not formed while inclining it by exactly an angle θ₁ from a normal direction 31 perpendicular to the transparent insulating substrate 10.

By this, part of the ultraviolet light 71 is blocked by the light blocking film 12, but the rest passes through the apertures 12a, then passes through the orientation film 13, substance layer 15, orientation film 3, transparent common electrode 2, and the transparent insulating substrate 1 and reaches the ultraviolet curing resin 40. Thus, cured portions 4a are formed at the portions of the ultraviolet curing resin 40 facing the apertures 12a.

Note that, the angle θ₁ is optimally determined according to the region for forming the micro-lenses, shape, etc.

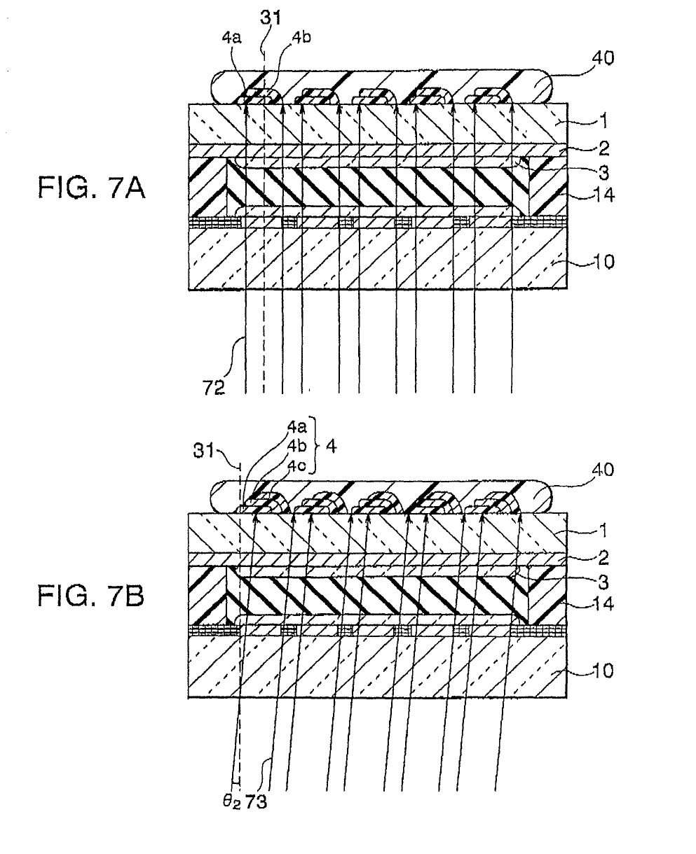

Next, as shown in FIG. 7A, an ultraviolet light 72 of for example parallel beams is uniformly irradiated from the side of the transparent insulating substrate 10 where the light blocking film 12 is not formed from the normal direction 31 perpendicular to the transparent insulating substrate 10.

By this, similarly, part of the ultraviolet light 72 is blocked by the light blocking film 12, but the rest passes through the apertures 12a and reaches the ultraviolet curing resin 40. Thus, cured portions 4b are formed at the portions of the ultraviolet curing resin 40 facing the apertures 12a.

Next, as shown in FIG. 7B, an ultraviolet light 73 of for example parallel beams is uniformly irradiated from the side of the transparent insulating substrate 10 where the light blocking film 12 is not formed while being inclined by exactly an angle θ₂ from the normal direction 31 perpendicular to the transparent insulating substrate 10.

By this, similarly, part of the ultraviolet light 73 is blocked by the light blocking film 12, but the rest passes through the apertures 12a and reaches the ultraviolet curing resin 40. Thus, cured portions 4c are formed at the portions of the ultraviolet curing resin 40 facing the apertures 12a.

Note that, the angle θ₂ is optimally determined according to the region for forming the micro-lenses, shape, etc. in the same way as the angle θ₁.

Here, if the angle is changed from θ₁ to 0 to θ₂ on the identical plane as described above, the semi-spherical micro-lenses shown in FIG. 10 are formed.

Accordingly, in order to form the semi-spherical micro-lenses shown in FIG. 4B, not only is the angle changed on the identical plane, but also irradiation is carried out at various angles from different planes.

At this time, by continuously or stepwise changing the angle and optimizing also the intensity of each ultraviolet light irradiated, it becomes possible to form micro-lenses having an intended shape.

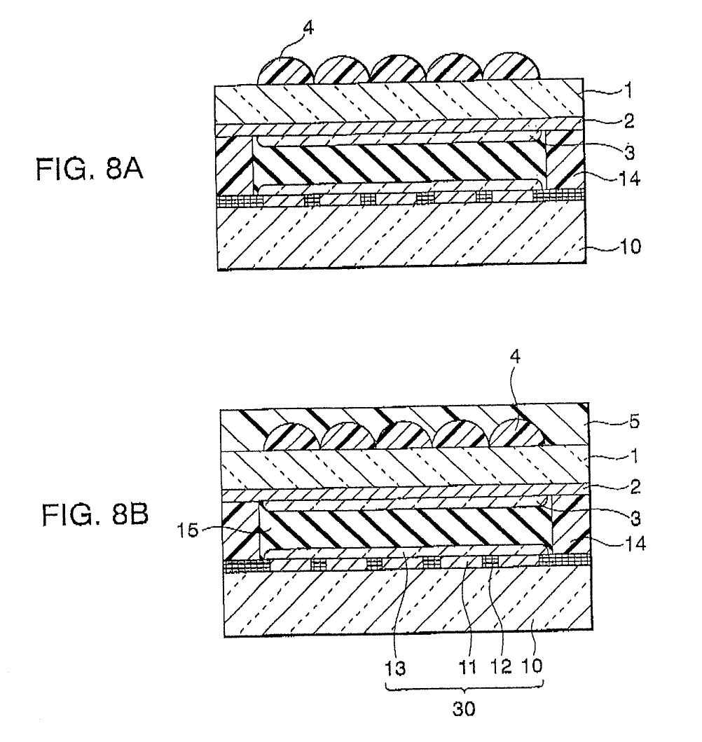

Next, as shown in FIG. 8A, the uncured portions of the ultraviolet curing resin 40 not irradiated by the ultraviolet light are removed by using a chemical such as an organic solvent, whereby a state where the cured portions of the ultraviolet curing resin 40 remain at positions facing apertures 12a of the light blocking film 12 as the micro-lenses 4 is exhibited.

By this, the micro-lenses 4 are slightly rounded and have a higher refractive index than their periphery, so have a micro-lens effect (convex lens effect).

Next, as shown in FIG. 8B, an adhesive layer 5 having a different refractive index from that of the micro-lenses 4, for example, a low refractive index, is formed on the transparent insulating substrate 1 provided with the micro-lenses 4.

In the following steps, a covering transparent insulating substrate 5 for protecting the micro-lenses 4 is adhered, and a not illustrated polarization plate or the like is formed outside of the TFT substrate 30 and the counter substrate 60 equipped with micro-lenses, whereby the image display device shown in FIG. 1 is reached.

According to the methods of production of micro-lenses and an image display device of the present embodiment, the micro-lens are formed after preparing the image display device as shown in FIG. 5B, therefore the positioning of the micro-lenses and the pattern of the light blocking film 12 and pixel electrodes 11 becomes unnecessary, so the matching is remarkably improved, the transmission rate is improved, and thus the display quality in the image display device can be improved.

Also, it is not necessary to prepare a micro-lens master, therefore the cost can be reduced in comparison with the related art method. Further, the disadvantage due to the deterioration of the micro-lens master can be avoided, so it becomes possible to form the micro-lenses without variations in shape.

Further, in the positioning between the counter substrate 50 and the TFT substrate 30, there is no disadvantage due to the superimposition and rubbing by the heat treatment, therefore it becomes possible to use a thermosetting sealing agent 14 having a high reliability, and an image display device having a high reliability as a liquid crystal projector used at a high temperature can be produced.

Second Embodiment

The present embodiment is different from the first embodiment in the method of irradiation of the ultraviolet light for forming the micro-lenses.

Below, an explanation will be made of the differences from the first embodiment.

The steps of FIG. 5A to FIG. 5B are carried out in the same way as the first embodiment, the TFT substrate 30 and the counter substrate 50 are formed, the TFT substrate 30 and the counter substrate 50 are arranged so as to face each other while providing a clearance therebetween, the peripheries are bonded by sealing by the sealing agent 14, for example a liquid crystal composition product is injected from a not illustrated injection hole into the clearance, the injection hole is closed, and therefore the liquid crystal composition is sealed and held between the substrates.

Next, as shown in FIG. 6A, for example an ultraviolet curing resin 40 having a high refractive index is formed on the transparent insulating substrate 1 on the surface opposite to the surface where the transparent common electrode 2 is formed.

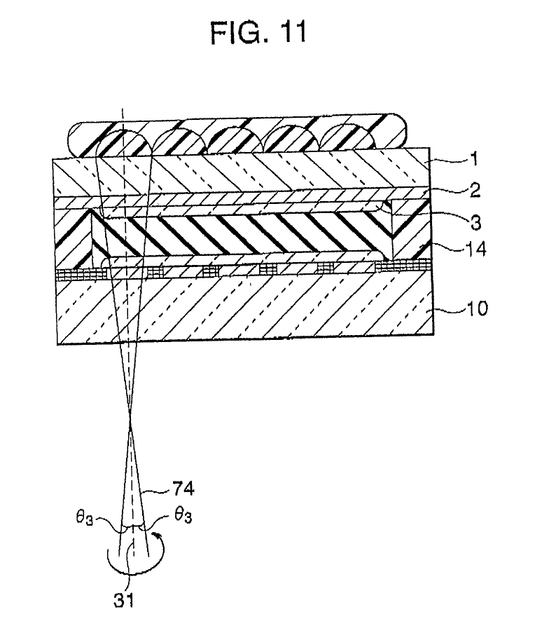

Next, as shown in FIG. 11, by irradiating ultraviolet light 74 while rotating the light source of the ultraviolet light, having an angle θ₃ with respect to the normal 31 of the TFT substrate 30, about the related normal 31, the semi-spherical micro-lenses 4 shown in FIG. 4B are formed.

As the following steps, in the same way as the first embodiment, by forming the adhesive layer 5 and the covering transparent insulating substrate 6 etc., the image display device shown in FIG. 4A is formed.

According to the image display device having micro-lenses of the present embodiment, in addition to similar effects to that by the first embodiment, the semi-spherical micro-lenses can be further simply formed, so the production steps can be decreased.

The methods of production of the micro-lenses and image display device of the embodiments of the present invention are not limited to the above explanation.

For example, in the present embodiment, after the substance layer 15 made of the liquid crystal composition was formed, the ultraviolet curing resin was coated to form the micro-lenses 4, but when for example a liquid crystal material having a low ultraviolet light resistance is used, it is also possible to inject the liquid crystal after forming the micro-lenses 4.

Also, in the present embodiment, the explanation was made by taking as an example a liquid crystal display device using liquid crystal as the substance layer 15 having an electrooptic effect, but the present invention can be similarly applied to other display devices such as an electroluminescence (EL) display device using electroluminescence.

Summarizing the effects of the present invention, according to the methods of production of micro-lenses and an image display device of the present invention, the positioning of the micro-lenses with respect to the light blocking layers and the pixel electrodes is unnecessary, so an image display device having micro-lenses capable of displaying high luminance and high contrast images can be produced.

While the invention has been described with reference to the preferred embodiments chosen for purpose of illustration, it should be apparent that numerous modifications could be made thereto by those skilled in the art without departing from the basic concept and scope of the invention.

What is claimed is:

1. A method of producing micro-lenses, including the steps of:
forming a plurality of pixel electrodes on a first light transmitting type substrate to form a first substrate;
forming counter electrodes on a second light transmitting type substrate to form a second substrate;
forming a light blocking layer having apertures in at least portions corresponding to said pixel electrodes on at least one of said first and second substrates;
bonding peripheries of said first and second substrates so that said pixel electrodes and said counter electrodes face each other with a clearance therebetween;
forming a focusing layer containing a photosensitive material on a surface of said second substrate facing said bonding surface;
irradiating light from said first substrate side to expose and cure the portions of said focusing layer facing the apertures of said light blocking film by light transmitted through the apertures of said light blocking layer; and
removing uncured portions of said focusing layer,
to thereby form the cured portions of said focusing layer as micro-lenses for focusing the light incident from said focusing layer side to the apertures of said light blocking layer.

2. A method of producing micro-lenses as set forth in claim 1, wherein the step of irradiating the light from said first substrate side, includes a step of using schematically parallel beams as the light.

3. A method of producing micro-lenses as set forth in claim 1, wherein the step of irradiating the light from said first substrate side, includes a step of irradiating at least two, beams having different angles with respect to a normal direction perpendicular to the light irradiated surface of said first substrate.

4. A method of producing micro-lenses as set forth in claim 1, wherein the step of irradiating the light from said first substrate side, includes a step of irradiating a beam having a predetermined angle with respect to the normal direction perpendicular to the light irradiated surface of said first substrate while rotating the same about the related normal direction.

5. A method of production of micro-lenses as set forth in claim 1, wherein the step of forming the focusing layer, includes a step of forming said focusing layer by an ultraviolet curing resin and,
the step of irradiating light from said first substrate side, includes a step of irradiating ultraviolet light as said light.

6. A method of producing micro-lenses as set forth in claim 1, further including, after the step of bonding the peripheries of the first and second substrates and before the step of irradiating the light from the first substrate side, a step of injecting a substance having an electrooptic effect into the clearances between the pixel electrodes and counter electrodes to form a layer of the substance.

7. A method of producing micro-lenses as set forth in claim 6, wherein the step of forming said layer of a substance, includes a step of injecting a liquid crystal composition as said substance to form a liquid crystal layer.

8. A method of producing micro-lenses as set forth in claim 1, further including, after the step of irradiating light from said first substrate side, a step of injecting a substance having an electrooptic effect into the clearances between the pixel electrodes and counter electrodes to form a layer of the substance.

9. A method of producing micro-lenses as set forth in claim 8, wherein the step of forming said layer of a substance, includes a step of injecting a liquid crystal composition as said substance to form a liquid crystal layer.

10. A method of producing an image display device, including the steps of:
forming a plurality of pixel electrodes on a first light transmitting type substrate and forming a switching element connected to the pixel electrodes to form a first substrate;
forming counter electrodes on a second light transmitting type substrate to form a second substrate;
forming on at least one of said first substrate and said second substrate a light blocking layer covering said switching element and clearances among said pixel electrodes and having apertures at least at portions corresponding to said pixel electrodes;
bonding peripheries of said first and second substrates so that said pixel electrodes and said counter electrodes face each other with a clearance therebetween;
forming a focusing layer containing a photosensitive material on a surface of said second substrate facing said bonding surface;
irradiating light from said first substrate side to expose and cure the portions of said focusing layer facing the apertures of said light blocking film by the light transmitted through the apertures of said light blocking layer; and
removing uncured portions of said focusing layer,
to thereby form the cured portions of said focusing layer as micro-lenses for focusing the light incident from said focusing layer side to the apertures of said light blocking layer.

11. A method of producing an image display device as set forth in claim 10, wherein the step of irradiating the light from said first substrate side, includes a step of using schematically parallel beams as the light.

12. A method of producing an image display device as set forth in claim 10, wherein the step of irradiating the light from said first substrate side, includes a step of irradiating at least two beams having different angles with respect to a normal direction perpendicular to the light irradiated surface of said first substrate.

13. A method of producing an image display device as set forth in claim 10, wherein the step of irradiating the light from said first substrate side, includes a step of irradiating a beam having a predetermined angle with respect to the normal direction perpendicular to the light irradiated surface of said first substrate while rotating the same about the related normal direction.

14. A method of producing an image display device as set forth in claim 10, wherein
the step of forming the focusing layer, includes a step of forming said focusing layer by an ultraviolet curing resin and,
the step of irradiating light from said first substrate side, includes a step of irradiating ultraviolet light as said light.

15. A method of producing an image display device as set forth in claim 10, further including, after the step of bonding the peripheries of the first and second substrates and before the step of irradiating the light from the first substrate side, a step of injecting a substance having an electrooptic effect into the clearances between the pixel electrodes and counter electrodes to form a layer of the substance.

16. A method of producing an image display device as set forth in claim 15, wherein the step of forming said layer of a substance, includes a step of injecting a liquid crystal composition as said substance to form a liquid crystal layer.

17. A method of producing an image display device as set forth in claim 10, further including, after the step of irradiating light from said first substrate side, a step of injecting a substance having an electrooptic effect into the clearances between the pixel electrodes and counter electrodes to form a layer of the substance.

18. A method of producing an image display device as set forth in claim 17, wherein the step of forming said layer of a substance, includes a step of injecting a liquid crystal composition as said substance to form a liquid crystal layer.
